(19) United States
(12) Patent Application Publication
(10) Pub. No.: US 2025/0288960 A1
(43) Pub. Date: Sep. 18, 2025

(54) FILTRATION SYSTEM

(71) Applicant: ORA GRAPHENE AUDIO INC., Montréal (CA)

(72) Inventors: Xinda LI, Montréal (CA); Kaiwen HU, Montréal (CA)

(21) Appl. No.: 18/861,960

(22) PCT Filed: May 3, 2023
(86) PCT No.: PCT/CA2023/050597

§ 371 Date: Oct. 31, 2024

Related U.S. Application Data
(60) Provisional application No. 63/337,679, filed on May 3, 2022.

(51) Int. Cl. B01D 69/12; B01D 67/00; B01D 69/10; B01D 71/02; B01D 71/22; B01D 71/38

(52) U.S. Cl. CPC B01D 69/1214; B01D 67/00791; B01D 69/107; B01D 71/0211; B01D 71/22; B01D 71/381; B01D 2325/22; B01D 2325/30

(57) ABSTRACT

There is provided a filtration system comprising a first vessel, a second vessel and a separation layer. The first vessel is adapted to receive a liquid phase. The second vessel is in fluid communication with the first vessel and is adapted to receive a permeate of the liquid phase. The separation layer separates the first vessel and the second vessel. The separation layer is porous and the pores allow for the filtering of the liquid phase. The separation layer comprises a graphitic material, crosslinkers and a polymer coating.

### TECHNICAL FIELD

This disclosure relates to the field of filtration systems, as well as methods of filtering liquid phases, mixtures, suspensions or solutions.

### BACKGROUND OF THE ART

Filtration systems are currently used in a variety of industries in the purification steps to recover a retentate or to remove a contaminant and recover a purified liquid phase. Filtration systems can have semi permeable filtration membranes and thus be used in osmosis or reverse osmosis systems. Osmosis systems, for example, can be used for dialysis or for the purification of salt water. Filtration systems can generally be categorized based on the pore size of the filtration membrane (e.g. microfiltration, nanofiltration, ultrafiltration and reverse osmosis). For example, a microfiltration is capable of filtering out bacteria and suspended solids but not viruses and ions. An ultrafiltration has a separation layer with a pore size of around 0.01 microns that can filter out bacteria, suspended solids, and some larger viruses. A nanofiltration has a separation layer with a pore size around 1 nm which generally filters out most organic molecules, most viruses, most organic matter and certain salts and larger ions. For example, a nanofiltration can remove divalent ions from water which make water hard. Reverse osmosis has a separation layer with a pore size of around 0.1 nm and can essentially remove all dissolved and suspended contaminants from water, even monovalent ions. In other words, a reverse osmosis can be used to desalinate water. Improvements in filtration systems are desired to achieve better balance between permeability and selectivity, as well as a better resistance to heat and abrasive chemicals. Particularly, it would be advantageous to identify novel materials that can act as the separation layer for these filtrations systems in order to achieve the desired improvements.

### SUMMARY

The present inventors have surprisingly found that graphitic materials in combination with crosslinkers and polymers can be used in the separation layer of filtration systems to achieve an improved filtration system. When compared to traditional separation layers such as separation membranes, the present separation layers comprising graphitic materials, crosslinkers and a polymer coating are more robust and have better mechanical properties. The present separation layers are also readily adaptable (e.g. can be produced with different pore sizes) to modify the balance between permeability and selectivity depending on the filtration application. The present separation layers offer improved resistance to heat and abrasive chemicals when compared to traditional separation membranes. This therefore allows the present separation layers to generally achieve a longer life cycle than traditional separation membranes and are more desirable in large scale industrial settings. The present separation layers, also offer an increased liquid flow across the separation layer when compared to traditional separation membranes, while still maintaining a higher rejection rate of target retentates.

In one aspect, there is provided a filtration system comprising: a first vessel adapted to receive a liquid phase; a second vessel in fluid communication with the first vessel and adapted to receive a permeate of the liquid phase; and a separation layer separating the first vessel and the second vessel, the separation layer having pores for filtering the liquid phase, and wherein the separation layer comprises a graphitic material, crosslinkers and a polymer coating.

In some embodiments, the graphitic material is selected from the group consisting of graphite, graphene, graphite oxide, graphene oxide, reduced graphene oxide, reduced graphite oxide and functionalized counterparts thereof.

In some embodiments, the filtration system is an ultrafiltration system, and the pores may have a size of between 0.005 to 0.09 μm.

In some embodiments, the filtration system is a nanofiltration system, and the pores can have a size of from 0.5 to 5 nm.

In some embodiments, the filtration system is a reverse osmosis filtration system, and the pores may have a size of less than 0.5 nm.

In some embodiments, the filtration system is a pervaporation filtration system, and the pores may have a size of less than 0.5 nm.

In some embodiments, the filtration system further comprises a porous support substrate covered at least partially by the separation layer.

In some embodiments, the porous support substrate comprises a material selected from the group consisting of polypropylene, polystyrene, polyethylene, polyethylene oxide, polyethersulfone, polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, ceramic, carbons, metals, silver, polycarbonate, nylon, aramid, and polyether ether ketone.

In some embodiments, the porous support substrate is a porous sheet wound into one of a spiral filtration module, a hollow porous tube, or a flat porous plate.

In some embodiments, the porous support substrate has an average pore size of from 0.01 μm to 50 μm, preferably 0.1 μm to 5 μm.

In some embodiments, the separation layer comprises a plurality of mono and/or multilayers.

In some embodiments, the plurality of mono and/or multilayers are linked by crosslinks of the crosslinkers.

In some embodiments, the separation layer comprises crosslinks between the graphitic material and the polymers formed by the crosslinkers.

In some embodiments, the graphitic material is present in the separation layer in a concentration of between 5 and 95 wt. %, preferably 50 to 80 wt. %.

In some embodiments, the polymers are present in the separation layer in a concentration of between and 95 wt. %.

In some embodiments, the polymers are selected from the group consisting of glycol, cellulose ethers, polyvinyl alcohol, polyethyleneimine, polyacrylic acid, polyurethane, polyepoxides polyisocyanates, polyvinyl acetates, polyacrylate, poly melamine, polyurea and copolymers thereof.

In some embodiments, the crosslinkers are present in the separation layer in a concentration of between 1 and 20 wt. %, preferably 1 and 10 wt. %.

In some embodiments, the crosslinkers are selected from the group consisting of from aldehyde, isocyanate, aziridine, bisacrylamide, carbodiimide, silicon chelates, zirconium chelates, titanium chelates, polyamines, polycarboxylates, polyepoxides, polyisocyanates, polyaziridines, multivalent metal ions, polyanhydrides, borates, alkylated melamine, alkylated urea, polyiscoyanate and phosphates.

In some embodiments, the filtration system further comprises a means of applying pressure in the first vessel to drive the flow of the liquid phase from the first vessel to the second vessel.

In a further aspect, there is provided a composition comprising: 50 to 80 wt. % of a graphitic material comprising a plurality of layers; 10 to 49 wt. % of polymers; and 0.1 to 10 wt. % of crosslinkers selected from titanium chelates, zirconium chelates, dialdehydes, polyisocyanates or polyaziridines.

In some embodiments, the crosslinkers are titanium chelates or zirconium chelates, such as titanium (IV) oxide bis(2,4-pentanedionate).

In some embodiments, the crosslinkers are dialdehydes, such as glyoxal or glutaraldehyde.

In some embodiments, the crosslinkers are polyisocyanates or polyaziridines, preferably polyaziridines such as trimethylolpropane tris(2-methyl-1-aziridinepropionate.

In some embodiments, the polymers have hydroxyl, amine, carboxyl and/or epoxy groups.

In some embodiments, the polymers are selected from polyvinyl alcohol, hydroxypropyl cellulose, polyacrylic acid, glycol, cellulose ethers, polyethyleneimine, polyurethane, polyepoxides and copolymers thereof.

In some embodiments, the thickness of the graphitic material is between 5 nm and 50 μm.

In some embodiments, the graphitic material is selected from the group consisting of graphite, graphene, graphite oxide, graphene oxide, reduced graphene oxide, and reduced graphite oxide or their chemically functionalized counterparts

In some embodiments, the polymers and the crosslinkers are present in a weight ratio of polymer to crosslinker of from 1:100 to 10:1.

Many further features and combinations thereof concerning the present improvements will appear to those skilled in the art following a reading of the instant disclosure.

### DESCRIPTION OF THE DRAWINGS

FIG. 1 is a schematic representation of a filtration system according to an embodiment of the present disclosure.

FIG. 2 is a schematic representation of an exemplary reverse osmosis filtration system according to an embodiment of the present disclosure.

FIG. 3 is a schematic representation of an exemplary pervaporation filtration system or a membrane distillation system according to an embodiment of the present disclosure.

FIG. 4 is a schematic representation of an exemplary dead-end filtration system according to an embodiment of the present disclosure.

FIG. 5 is a schematic representation of a crossflow filtration system according to an embodiment of the present disclosure.

FIG. 6 is a schematic representation of the crosslinking between the graphitic material and the polymer.

FIG. 7 is a schematic representation of the crosslinking between the graphitic material, the polymers and crosslinkers.

FIG. 8 is a graph showing the permeate mass (deionized water) crossing a reduced graphite oxide (rGO) membrane (1) and a graphene oxide-polymer composite (GOPC) (2) in function of time.

FIG. 9A is a graph showing the permeate mass crossing for a 5 wt. % lignin solution and the flow rate across a GOPC membrane.

FIG. 9B is a graph showing the permeate mass crossing for a 5 wt. % lignin solution and the flow rate across a rGO membrane.

FIG. 10 is a graph showing the mass of permeate in function of time for 20 cycles of filtration across a GOPC membrane.

FIG. 11 is a graph of the lignin rejection rate in function of the filtration cycle.

FIG. 12 is a photograph of membranes after a wet adhesion tests.

FIG. 13 is a photograph of membranes after a dry adhesion tests.

FIG. 14A is a photograph of membranes before a dry peeling test.

FIG. 14B is a photograph of a strongly crosslinker membrane after the dry peeling test.

FIG. 14C is a photograph of an uncrosslinked membrane after the dry peeling test.

### DETAILED DESCRIPTION

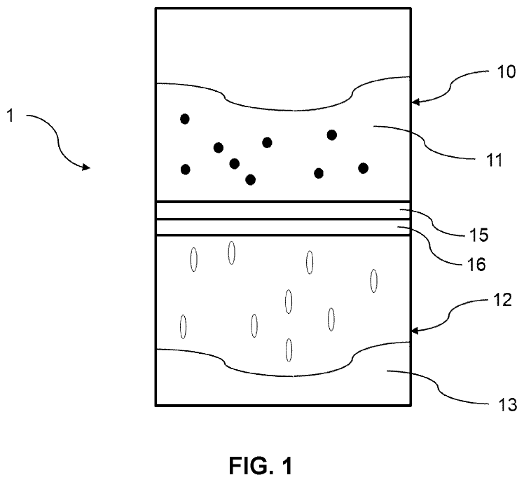

Making reference to FIG. 1, there is provided a filtration system 1 having a first vessel 10 containing a liquid phase 11 that requires filtration. The filtration system 2 has a second vessel 12 in fluid communication with the first vessel 10. The second vessel 12 receives the permeate 13 of the liquid phase 11 being filtered. The liquid phase 11 is filtered through a separation layer 15 which is optionally supported by a porous substrate 16. The separation layer 15 is porous to allow the liquid phase 11, and organisms, particles, molecules, and/or ions that have a size below the pore size, to go through into the second vessel 12. The separation layer comprises, consists essentially or consists of a graphitic material, optionally a base coat layer, crosslinkers and a polymer coating. The base coat layer is an optional adhesive layer that can be placed on the substrate to improve adhesion of the graphitic material to the substrate. In some embodiments, the thickness of the separation layer or of the graphitic material is between 5 nm and 50 μm.

The term “graphitic material” as used herein refers to a material selected from one or more of graphene, graphite, graphene oxide, graphite oxide, reduced graphene oxide and reduced graphite oxide. The term “graphitic oxide material” as used herein refers to a material selected from one or more of graphene oxide, graphite oxide, reduced graphene oxide and reduced graphite oxide.

Graphite is a crystalline form of carbon formed of a stack of 2D lattices of sp²-hybridized carbon organized in a hexagonal structure. In its thinnest expression, a single layer of the hexagonal structure of graphite is referred to as graphene. Depending on the context, structures having up to 10, and even in some cases up to one hundred layers of the hexagonal structure can continue to be referred to as graphene, and the frontier between graphite and graphene can thus be fuzzy. In this specification, structures having up to 10 layers of graphene will be referred to as graphene, and structures having more than 10 layers of graphene will be referred to as graphite. Likely due to the thickness distinction between the two, it is common to refer to particles of graphite as “flakes” and to particles of graphene as “sheets”. Accordingly, in some embodiments, the separation layer comprises a plurality of mono and/or multilayers of graphene.

Graphite oxide is a compound of carbon, oxygen and hydrogen in variable ratios. The carbon mass percentage is commonly around 45% and the typical carbon to oxygen ratio can be between 1.8 and 2.9 in accordance with some common definitions which can be retained herein. The native functional groups on graphite oxide include hydroxyls, epoxides, carbonyls, carboxylic acids and organosulfates. Graphene oxide is also a compound of carbon, oxygen and hydrogen in similar ratios to graphite oxide, given the similarity between the materials. Reduced graphite oxide, and reduced graphene oxide are similar to their graphite oxide and graphene oxide counterparts, except for the fact that they have gained electrons (exhibit a decrease in their oxidation state) which is typically achieved by chemical, thermal, photo, hydrothermal reduction or combination of different categories of reduction. The maximal reduction of graphene oxide leads to graphene, whereas the maximal reduction of graphite oxide leads to graphite. Similarly to the definitions adopted above, the expression graphene oxide or reduced graphene oxide will be used to refer to structures having up to 10 layers and the expressions graphite oxide or reduced graphite oxide will be used to refer to structures having more than 10 layers in this specification.

Graphitic materials, such as graphitic oxide materials, can be mixed with one or more other active materials in a formulation and then formed into a layer. One or more layers can be stacked, used in a flat configuration, or shaped. Fabrication techniques can include solvent casting followed with doctor blade, roller coating, vacuum or pressure filtration, etc. Typically, the formulation includes all the “active materials” in a solvent, and the solvent evaporates leaving only the active materials in the layer. The more than one active material forming the remaining layer will be collectively referred to herein as a (final) chemical composition. In an example embodiment, graphitic oxide materials are preferred over graphitic materials. The concentration of graphitic oxide material in the resulting chemical composition can be at least 60 wt %, preferably at least 70 wt %, more preferably at least 75%, for instance, in which case the layer can be referred to as a graphitic oxide layer. The graphitic material can be a single layer of such chemical composition, or of successive layers which can be applied onto one another. The successive layers can be of the same chemical composition, or of different materials.

Chemically functionalized graphitic materials are those, which are chemically modified to bear non-native chemical groups through covalent bonding or non-covalent bonding such as π-π interaction.

In some embodiments, the separation layer is a graphene oxide-polymer composite (GOPC) and comprises: (a) graphene oxide and its derivatives, (b) a polymer coating, and (c) chemical crosslinkers. The amount of graphene oxide and its derivatives in the resulting GOPC separation membranes is preferably between 50% to 80% by weight but can be between 5% and 95% by weight. The amount of polymer in the resulting GOPC separation membranes can be between 0.1% and 95%, between 1% and 95%, between 1% and 75% or between 5% and 95% by weight. The amount of chemical crosslinkers in the resulting GOPC separation membranes can be between 0.1% to 75%, between 0.5% to 70%, between 5% and 60%, or between 1% and 20% by weight, with a preferable range from 1% to 10%. In some embodiments, the GOPC layer can be chemically, thermally or photothermally reduced to introduce hydrophobicity or additional stability for certain separation applications, where a more hydrophobic fluid is used, or a higher membrane stability is desired. The molecular weight cut-off of GOPC separation layer can be tuned by the mass ratio between the graphene oxide and polymer, the flake size of graphene oxide, the polymer type, and the crosslinker content and type. Other examples of graphitic materials suitable for the separation layer of the present disclosure include but are not limited to pristine graphene synthesized via exfoliation methods, graphene nano-platelets (GNP), or turbostratic graphene.

In some embodiments, the hydroxyl groups, carboxyl groups, ketone groups and epoxy groups of the graphitic material in the separation layer (e.g. when graphene oxide sheets are the graphitic material) are chemically modified into other functionally groups, including but not limited to chloroformate groups, amine groups, acrylic groups, and thiol groups.

In some embodiments, the graphitic material is a graphitic oxide material which can be single or multilayer graphite oxide (GO) or reduced graphite oxide (rGO) sheets with particle sizes ranging from 10 nm to 500 μm, preferably 1 μm to 50 μm. The particle size distribution of GO/rGO sheets may directly correlate to the density of the material.

In some embodiments, the separation layer, preferably comprising GOPC, can have a thermal stability limit greater than about 70° C. In some embodiments, the separation layer, for example comprising GOPC, has a flux of at least about 286 litres per square meter per hour per bar (L/(m² hr bar)) at room temperature with deionized water. In some embodiments, the molecular weight cut-off of the separation layer, preferably comprising GOPC, is in the range of about 100 Daltons to about 1000 Daltons.

The separation layer of the present disclosure can have different pore sizes to allow performing ultrafiltrations, nanofiltrations, pervaporation filtrations, membrane distillations, and reverse osmosis filtrations. The filtration system of the present disclosure may be set up as a dead-end filtration or as a crossflow filtration. In one embodiment, the filtration system is an ultrafiltration system. The separation layer of the ultrafiltration system can have pores of between 0.005 and 0.09 μm, between 0.005 and 0.2 μm or about 0.01 μm. The term “about” as used herein can be interpreted as meaning ±5%, ±10%, ±15% or ±20%. In one embodiment, the filtration system is a nanofiltration system. The separation layer of a nanofiltration system can have pores of between 0.5 and 5 nm, between 0.5 and 2 nm or about 1 nm.

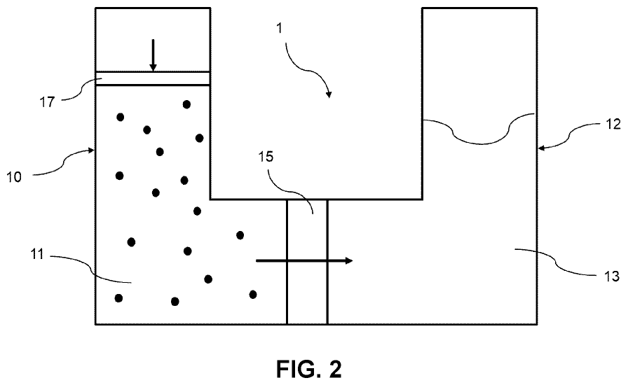

In one embodiment, as illustrated in FIG. 2, the filtration system 1 can be a reverse osmosis filtration system. The separation layer of a reverse osmosis filtration system can have pores of less than 0.5 nm, less than 0.25 nm or about 0.1 nm. Making reference to FIG. 2, the reverse osmosis filtration system generally further comprises a means 17 of applying pressure in the first vessel 10 to drive the flow of the liquid phase 11 from the first vessel 10 to the second vessel 12. The means 17 can for example be a lever or piston, or can be the indirect application of pressure through the use of vacuum pump or the like to apply a pressure differential between the first vessel 10 and the second vessel 12. The means 17 for applying pressure to the first vessel 10 can also be used in ultrafiltration, nanofiltrations and other types of filtrations although the set up may be different. The means 17 is helpful in accelerating the filtration particularly when the pore size of the separation layer is small (e.g. less than 10 μm).

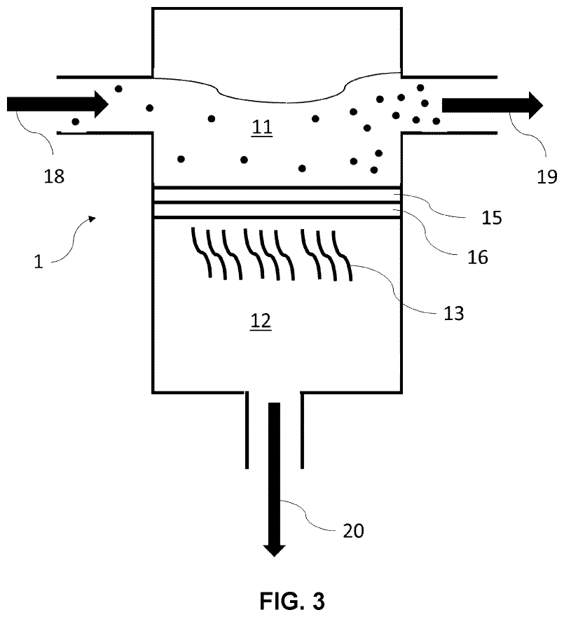

In one embodiment, as illustrated in FIG. 3, the filtration system 1 can be a pervaporation filtration system or a membrane distillation system. The separation layer of a pervaporation filtration system or a membrane distillation system can have pores of less than 0.5 nm, less than 0.25 nm or less than 0.1 nm. Making reference to FIG. 3, the pervaporation filtration system or the membrane distillation system has a feed 18 of the liquid phase 11 that passes across the separation layer 15 to then become the retentate 19. The second vessel 12 receives the permeate 13 of the liquid phase 11 that passed across the separation layer 15. A vacuum 20 or negative pressure can be applied in the second vessel 12 to drive the flow and gasification of the liquid phase across the separation layer 15. In the embodiment illustrated in FIG. 3, the permeate 13 is a gaseous phase. Accordingly, in a pervaporation filtration system a feed 18 of liquid phase 11 comprising a solute can be concentrated and a concentrated retentate 19 can be obtained.

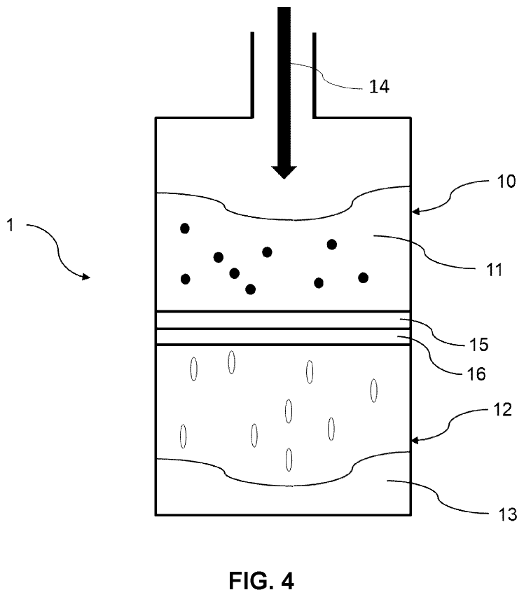

In one embodiment, as illustrated in FIG. 4, the filtration system can be a dead-end filtration. In a dead-filtration the liquid phase 11 is generally stagnant and adjacent to the separation layer 15. A pressure 14 can be applied to drive the flow of the liquid phase 11 across the separation layer 15 into the second vessel 12.

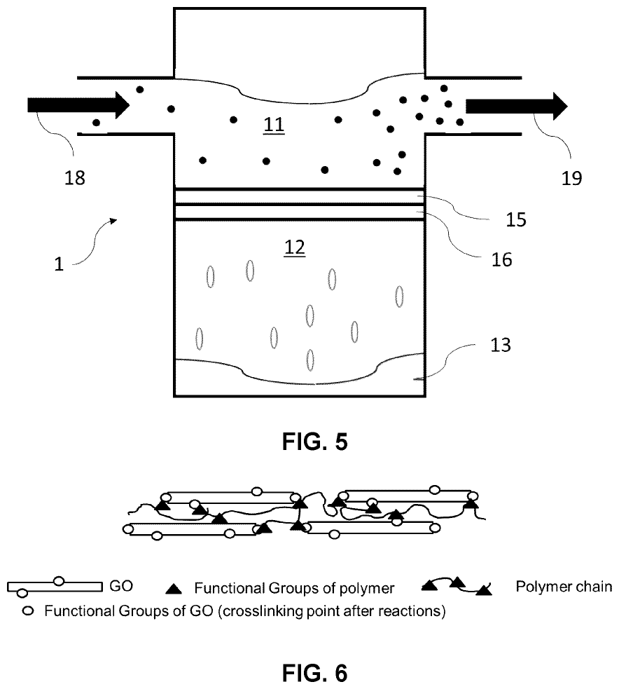

In one embodiment, as illustrated in FIG. 5, the filtration system can be a crossflow filtration. In such an embodiment, the liquid phase 11 flows across the separation layer 15 and at least a portion of the liquid phase 11 crosses the separation layer 15 into the second vessel. Crossflow filtrations can be particularly suitable for concentrating a liquid a phase.

The separation layer comprises a polymer coating. The polymer coating generally covers at least a portion of the graphitic material, and preferably substantially covers the graphitic material. The polymer is also crosslinked with the graphitic material. FIG. 6 shows an exemplary schematic of the crosslinks that can occur between the polymer and functional groups of graphite oxide. In some embodiments, the polymer contains one or more of functional groups, including but not limited to hydroxyl groups, carboxyl groups, ketone groups, epoxy groups, chloroformate groups, amine groups, acrylic groups, and thiol groups. Typical polymers include but are not limited to polyethylene glycol (PEG), cellulose ethers, polyvinyl alcohol (PVA), polyethyleneimine (PEI), polyacrylic acid (PAA), polyurethane (PU), polyepoxides polyvinylpyrrolidone (PVP), polyisocyanate, polyvinyl acetate, polyacrylate, poly melamine, polyurea and their copolymers. The cellulose ether may be selected from a group consisting of carboxymethylcellulose (CMC), hydroxypropymethylcellulose (HPMC), methylcellulose (MC), hydroxypropylcellulose (HPC) and hydroxyethylcellulose (HEC). In some preferred embodiments, the polymer is selected from the group consisting of glycol, cellulose ethers, polyvinyl alcohol, polyethyleneimine, polyacrylic acid, polyurethane, polyepoxides and copolymers thereof.

In some embodiments, the polymers are from 5 wt. % to 95 wt. % of the separation layer and the graphitic material is from 5 wt. % to 95 wt. % of the separation layer. The type of polymer as well as the quantity of polymer influence the pore size of the separation layer. In general, and without wishing to be bound by theory, increasing the polymer content relative to the graphitic material would increase porosity, while decrease the polymer content would reduce the porosity.

In some embodiments, the polymers are or include UV curable polymers and accordingly photo initiators are also included. For example, the polymers can be UV-curable polyurethane or polyvinyl acetate. In such embodiments, the concentration of the polymers can be in the range of from 1 to 49 wt. %. Having a UV-curable polymer allows for performing a post treatment on the GO coating to increase the stability of GO on the substrate. The UV treatment can preferably remove some of the oxygen and thus make the coating more stable in aqueous phases. When the coating is made up of multiple sheets (stacks of sheets) the UV treatment can be beneficial in reducing the distance between the layers compared to a non-UV treated coating. The UV-curable polymer also improves the adhesion to the substrate. Alternatively, heat cured polymers can also be used.

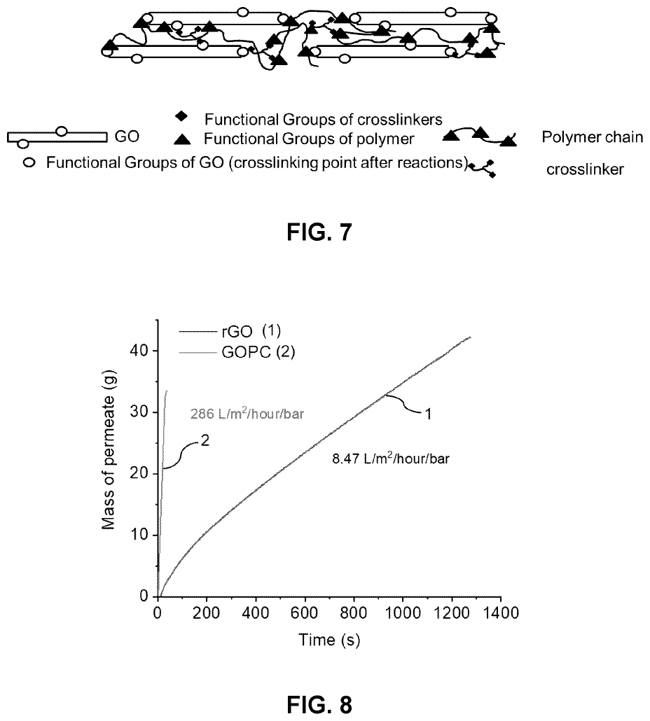

Finally, the separation layer also comprises chemical crosslinkers. The chemical crosslinkers can form crosslinks with the graphitic material and with the polymer. For example, as shown in FIG. 7 the chemical crosslinkers can form crosslinks with the functional groups of graphite oxide and the functional groups of the polymers. In some embodiments, the chemical crosslinkers are selected from aldehyde (e.g. dialdehyde), isocyanate, aziridine, bisacrylamide, carbodiimide (e.g. polycarbodiimide), silicon chelates, zirconium chelates, titanium chelates, polyamines, polycarboxylates, polyepoxides, polyisocyanates, polyaziridines, multivalent metal ions, polyanhydrides, borates, phosphates, alkylated melamine, alkylated urea, polyiscoyanate and combinations thereof.

In some embodiments, the crosslinkers are or include titanium chelates and/or zirconium chelates. For example, the crosslinkers can be titanium (IV) oxide bis(2,4-pentanedionate). These chelates can form bonds with hydroxyl and carboxyl functional groups and work to crosslink these sites. They can act as a catalyst in esterification reactions. They improve stability in water, adhesion, and hardness.

In some embodiments, the crosslinkers are or include aldehydes, such as dialdehydes. For example, the crosslinkers can be glyoxal or glutaraldehyde. These crosslinkers can form bonds with hydroxyl and carboxyl functional groups and work to cross link these sites. They can tune the length of crosslinks, improve stability in water, adhesion, and hardness. They can also be used to tune the pore size. For example, by increasing the content or adding aldehyde crosslinkers the pore size of the separation layer can be reduced.

In some embodiments, the crosslinkers are or include carbodiimides, such as polycarbodiimides. For example, the crosslinkers can be polycarbodiimide, N,N′-Diisopropylcarbodiimide. These crosslinkers can react and crosslink with carboxylic acid groups. They improve the stability in water, the adhesion, and the hardness. They can also be used to tune the pore size. For example, by increasing the content or adding carboddimides crosslinkers the pore size of the separation layer can be reduced.

In some embodiments, the crosslinkers are or include polyisocyanate. In some embodiments, the polyisocyanate is included in a concentration of from 0.1 to 75% by weight. The polyisocyanate can have a functionality greater than 2, and preferably greater than 3. For example, the crosslinkers can be hexamethylene diisocyanate (HDI), methylene diphenyl diisocyanate (MDI), and/or blocked-HDI. These crosslinkers can form bonds with hydroxyl and carboxyl functional groups and work to cross link these sites. They can be used to tune the length of crosslinks. They also improve stability in water, adhesion, and hardness. They can tune the pore size and promote faster crosslinking reactions. For example, by increasing the content or adding polyisocyanate crosslinkers the pore size of the separation layer can be reduced. The polyisocyanate can lead to the formation of inter and intra sheet covalent urethane linkages (R—NH—C(O)—O—) between GO and crosslinker through reaction of isocyanate groups and hydroxyl groups on GO, or similarly the formation of inter and intra sheet covalent amide linkages (R—NH—C(O)—) between GO and crosslinker through reaction of isocyanate groups and carboxylic acid groups on GO.

In some embodiments, the crosslinkers are or include polyamine. For example, the crosslinkers can be polyetheramine and/or 1,2-diaminoethane. These crosslinkers can react and crosslink with carboxylic acid functional groups. They can improve stability in water, adhesion, and hardness. They can tune the pore size and promote faster crosslinking reactions. For example, by increasing the content or adding polyamine cross

linkers the pore size of the separation layer can be reduced.

In some embodiments, the crosslinkers are or include polyepoxides. For example, the crosslinkers can be triglycidyl-2 aminophenol. These crosslinkers can react and crosslink carboxylic acid functional groups. They can improve stability in water, adhesion, and hardness. They can tune the pore size and promote faster crosslinking reactions. For example, by increasing the content or adding polyepoxides crosslinkers the pore size of the separation layer can be reduced.

In some embodiments, the crosslinkers are or include polyaziridines. For example, the crosslinkers can be trimethylolpropane tris(2-methyl-1-aziridinepropionate. These crosslinkers can react and crosslink carboxylic acid functional groups. They can improve stability in water, adhesion, and hardness. They can tune the pore size and promote faster crosslinking reactions. For example, by increasing the content or adding polyaziridines crosslinkers the pore size of the separation layer can be reduced.

In some embodiments, the crosslinkers are or include alkylated melamine and/or urea crosslinkers. These crosslinkers can have a functionality greater than 2, and preferably greater than 3. These crosslinkers can lead to the formation of inter and intra sheet covalent ether linkages (—O—R3—N(R1)—R2—O—) between GO and crosslinker through reaction of alkylated amino groups and hydroxyl groups on GO, where R3 and R2 are C1 to C6 alkyl groups.

In some embodiments, the separation layer comprises the crosslinkers in a concentration of between 0.1 and 75 wt. %, between 1 and 70 wt. %, between 3 and 65 wt. %, between 5 and 60 wt. %, between 1 and 20 wt. %, between 1 and 17.5 wt. %, between 1 and 15 wt. %, between 1 and 10 wt. %, between 2 and 20 wt. %, between 4 and 20 wt. %, between 5 and 20 wt. %, between 2 and 17.5 wt. %, between 4 and 15 wt. %, or between 4 and 10 wt. %.

The present disclosure further provides a composition comprising or consisting of (a) 50 to 80 wt. % of a graphitic material comprising a plurality layers, (b) 10 to 49 wt. % of polymers, and (c) 0.1 to 10 wt. % of crosslinkers selected from titanium chelates, zirconium chelates, dialdehydes, polyisocyanates or polyaziridines. In some embodiments, the concentration of the crosslinkers is 0.2 to 10 wt. %, 0.5 to 10 wt. %, or 1 to 10 wt. %. This composition is particularly suitable for use as a separation layer in filtration systems and in methods of performing filtrations. The titanium chelates, zirconium chelates, dialdehydes and polyaziridines crosslinkers are as described above, the polymers are as described above and the graphitic material is as described above. In some embodiments, the composition comprises the polymer and the crosslinker in a weight ratio of polymer to crosslinker of between 1:100 to 10:1, between 4:1 and 2:1, between 3.5:1 and 2.5:1, or about 3:1. In one non-limitative exemplary embodiment, the composition comprises PVA as the polymer and dialdehyde as the crosslinker. In such embodiment, the weight ratio of PVA to dialdehyde may be of between 4:1 and 2:1, between 3.5:1 and 2.5:1, or about 3:1.

Turning back to FIG. 1, in some embodiments, the filtration system optionally comprises a support substrate 16. Accordingly, in some embodiments, the filtration apparatus comprises: (a) a porous support substrate, and (b) a GOPC separation layer deposited over at least a part of the porous support substrate. The GOPC separation layer can include a plurality of mono and multilayer graphene oxide sheets and each of the graphene oxide sheets can be linked to the adjacent polymer chains via a chemical crosslinker as previously shown in FIGS. 6 and 7. The addition of polymer allows strong adhesion of the GOPC layer to the substrate while crosslinking between GO-polymer and among GO sheets provides good stability of the GOPC during the separation process. As previously stated, the support substrate is optional. Thus, in some embodiments, the filtration apparatus only comprises a GOPC layer without a porous support substrate. In such cases, the GOPC layer serves as a freestanding separation layer.

In some embodiments, the porous support substrate includes a material selected from polypropylene, polystyrene, polyethylene, polyethylene oxide, polyethersulfone (PES), polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, ceramic, carbons, metals, silver, polycarbonate, nylon, Kevlar or other aramid, or polyether ether ketone, woven, non-woven synthetic or natural fabrics.

In some embodiments, the forms of the support porous substrate include a porous sheet which is configured to be wound into a spiral filtration module, a hollow porous tube/fiber, and a flat porous plate. The support porous substrate can have an average pore size of 0.01 μm to 50 μm with a preferable range from 0.1 to 5 μm.

The separation layers and porous substrates described herein can be produced or fabricated by various processes. In an exemplary fabrication process for a separation layer, a precursor solution of GOPC is first prepared by mixing graphene oxide, polymers, chemical crosslinkers and solvent. Then the precursor solution of GOPC is deposited on the support porous substrate using flexography, spin coating, dip coating, doctor-blade coating, slot-die coating method, spray coating, to enable a roll-to-roll manufacturing process. The thickness of dried GOPC can be between 5 nm and 50 μm depending on the coating method.

In one example, the graphene oxide-polymer composite separation layers of the present disclosure can be used for concentration, removal, and purification of different substances, including but not limited to inorganic salts, lignin, lactose, humic acid and fulvic acid.

In one embodiment, there is provided a method of concentrating black liquor using a reverse osmosis filtration system as described herein. The black liquor can comprise lignin, sodium sulfate, sodium carbonate, sodium hydrosulfide, sodium thiosulfate, sodium hydroxide, hemicellulose, methanol, organic acid and water. In one example, the separation layer can be a GOPC separation layer that has at least about 5 L/(m² hr bar) at room temperature with weak black liquor, and has at least about 10 L/(m² hr bar) at 70° C. with weak black liquor. In some embodiments, at least a portion of the lignin is rejected by the GOPC separation membrane. In some embodiments, at least 99% of the lignin is rejected by the graphene oxide membrane.

In some embodiments, at least a portion of sodium sulfate, sodium carbonate, sodium hydrosulfide, sodium thiosulfate, and sodium hydroxide, is rejected by the separation layer of the present disclosure (e.g. a GOPC separation layer). In some embodiments, at least 90% of the sodium sulfate, sodium carbonate, sodium hydrosulfide, sodium thiosulfate, and sodium hydroxide are rejected by the separation layer of the present disclosure (e.g. a GOPC separation layer).

In one embodiment, there is provided a method of filtrating milk to remove lactose using the filtration systems described herein (e.g. with a GOPC separation layer in a reverse osmosis system). The milk generally comprises lactose, fat, protein, minerals, and water. In some embodiments, the separation layer of the present disclosure (e.g. a GOPC separation layer) has at least about 25 L/(m² hr bar) at room temperature with the commercial milk (with about 5 wt. % lactose). In some embodiments, at least a portion of the lactose is rejected by the GOPC separation membrane. In some embodiments, at least 90% of the lactose is rejected by the GOPC separation membrane at room temperature with the commercial milk (with about 5 wt. % lactose).

In one embodiment, there is provided a method of removing humic acid and fulvic acid from drinking water using a filtration system as described herein (e.g. GOPC separation layer in a reverse osmosis system). The separation layer of the present disclosure (e.g. a GOPC separation layer) may have at least about 2.5 L/(m² hr bar) at room temperature with an aqueous solution of 4 wt. % humic acid, and 1 wt. % fulvic acid. In some embodiments, at least a portion of the humic acid and fulvic acid is rejected by the separation layer (e.g. GOPC separation membrane). In some embodiments, at least 99% of the humic acid and fulvic acid is rejected by the separation layer (e.g. GOPC separation layer) at room temperature with an aqueous solution of 4 wt. % humic acid, and 1 wt. % fulvic acid.

In one embodiment, there is provided a method of seawater desalination using a filtration system as described herein (e.g. a GOPC separation layer in a reverse osmosis system). The seawater can comprise sodium chloride, magnesium chloride, sodium sulfate, calcium chloride, potassium chloride, sodium bicarbonate, and other trace amount inorganic salts. The separation layer (e.g. a GOPC separation layer) can have at least about 200 L/(m² hr bar) at room temperature with seawater (with salinity about 3.5 wt. %). In some embodiments, at least a portion of the inorganic salts is rejected by the separation layer (e.g. a GOPC separation layer). In some embodiments, at least 90% of the inorganic salts is rejected by the separation layer (e.g. GOPC separation layer) at room temperature with seawater (with salinity about 3.5 wt. %).

In one embodiment, there is provided a method of lithium concentration from brine using the separation layer of the present disclosure (e.g. a GOPC separation layer in pervaporation, forward osmosis, reverse osmosis, or membrane distillation system). The use of a GOPC separation as described herein potentially offers a 20-time faster concentration speed and lowers the plant footprint by about 10 times.

It also possible to perform oil separation from emulsified water with the filtration systems described herein, particularly with a GOPC separation layer.

### EXAMPLE

A GOPC separation layer with PVA polymers and zirconium chelate crosslinkers with a PES support substrate was produced by the following protocol: 1) a 2 wt. % GO solution and 1 wt. % PVA solution were provided 2) 8 g of GO solution and 24 g DI water were mixed for 10 min with an overhead mixer, 3) 10 g of PVA solution were added, 4) a pH titration to a pH of 7.5˜8 was performed using a 10 wt. % NaOH solution, 5) 25 μL of zirconium chelates were added into the solution which was mixed for another 10 min, 6) the PES membrane (0.22 μm pore size) was wetted with dionized (DI) water, 7) the as-prepared solution was coated with 20 μm of wire-bar, and 8) the coated PES membrane was dried in a convection oven at 100° C.

A GOPC separation layer with HPMC polymer and glyoxal crosslinkers, with a polypropylene support substrate was produced by the following protocol: 1) a 2 wt. % GO solution and 1 wt. % HPMC solution were provided 2) 8 g of GO solution and 24 g DI water were mixed for 10 min with an overhead mixer, 3) 10 g of HPMC solution were added, 4) 0.2 g of glyoxal were added into the solution which was mixed for another 10 min, 5) plasma treatment was applied treat a polypropylene (PP) membrane, 6) the PP membrane (0.2 μm pore size) was wetted with DI water, 7) the as-prepared solution was coated with 20 μm of wire-bar on PP membrane, and 8) the coated PP membrane was dried in a convection oven at 100° C.

A GOPC separation layer with PVA polymer and glyoxal crosslinkers, with a PES support substrate was produced by the following protocol: 1) a 2 wt. % GO solution and 1 wt. % PVA solution were provided 2) 8 g of GO solution and 24 g DI water were mixed for 10 min with an overhead mixer, 3) 10 g of PVA solution were added, 4) 0.2 g of glyoxal were added into the solution which was mixed for another 10 min, 5) plasma treatment was applied treat a PES membrane, 6) the PES membrane (0.22 μm pore size) was wetted with DI water, 7) the as-prepared solution was coated with 20 μm of wire-bar, 8) the coated PES membrane was dried in a convection oven at 80° C., 9) the oven-dried coated PES membrane was dipped in a 25 wt. % glyoxal solution, and 10) the coated PES membrane was then dried in a convection oven at 100° C.

A reduced graphite oxide rGO was prepared by the following protocol: 1) a 2 wt. % GO solution and 1 wt. % PVA solution and a 20 wt. % ascorbic acid (AA) solution were provided, 2) they were all added to a 50 mL glass beaker, 3) the contents of the beaker were mixed on a magnetic stirring plate for 15 minutes, 4) a PES membrane (0.22 μm pore size) was wetted with DI water, 5) the as-prepared solution was coated with 20 μm of wire-bar, 6) then dried in a convection oven at 80° C. for 15 minutes, and 7) finally heat pressed in-between 2 sheets of parchment paper at 80° C. for 15 minutes at a pressure of 0.7 MPa.

The flow of permeate of the GOPC and rGO separation layers which both had a PES support substrate and PVA polymer were compared with with a dead-end filtration setup. The flow used was DI water at room temperature (20° C.). The pressure was set at 50 PSI with compressed air. A motor with a propellor was installed right above the separation layer to provide the agitation (120 RPM). The results are shown in FIG. 8. The GOPC significantly outperformed the rGO with 286 L/m²/hour/bar compared to 8.47 L/m²/hour/bar.

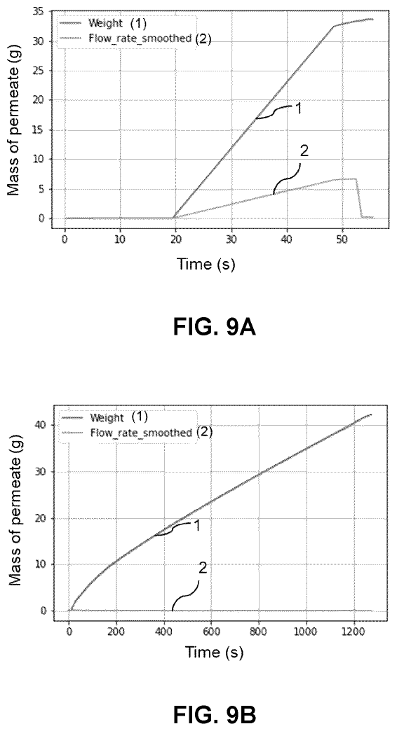

The flow rate of the GOPC and rGO were further evaluated and compared with a 5 wt. % lignin solution at 20° C. The parameters of the filtration are provided in Table 1 below. The results are provided in FIGS. 9A and 9B.

TABLE 1
Parameters of the lignin filtration

| | | | | | Flux. | |
|---|---|---|---|---|---|---|
| | | | | | Normalized | Flux. Not- |
| | | | | | by pressure | Normalized |
| | | Mass flow | TMP | Density | (L m⁻² h⁻¹ | by pressure |
| Solution | A (m²) | rate (g h⁻¹) | (bar) | (g L⁻¹) | bar⁻¹) | (L m⁻² h⁻¹) |
| 5 wt % lignin | 0.004 | 33.515 | 3.447 | 1000.000 | 2.385 | 8.23 |

The results obtained in the present example were also compared with membranes of the literature and presented in Table 2 below.

TABLE 2
Comparison of GOPC performance with other membranes

| | | | Flux. | |
|---|---|---|---|---|
| | | Temper- | Normalized | Lignin |
| | | ature | by pressure (L | rejec- |
| Membrane | Solution | C. | m⁻² h⁻¹ bar⁻¹) | tion % |
| GOPC | 5 wt % lignin | RT | 4.99 | >99.9 |
| rGO from | Weak black | RT | 0.5 | 98 |
| literature | liquor | | | |
| UF-Hydrophilic | Weak black | RT | 10.3 | <90 |
| 100 kDa uncoated | liquor | | | |
| UF-Hydrophilic | Weak black | RT | 4.5 | <90 |
| 30 kDa coated | liquor | | | |

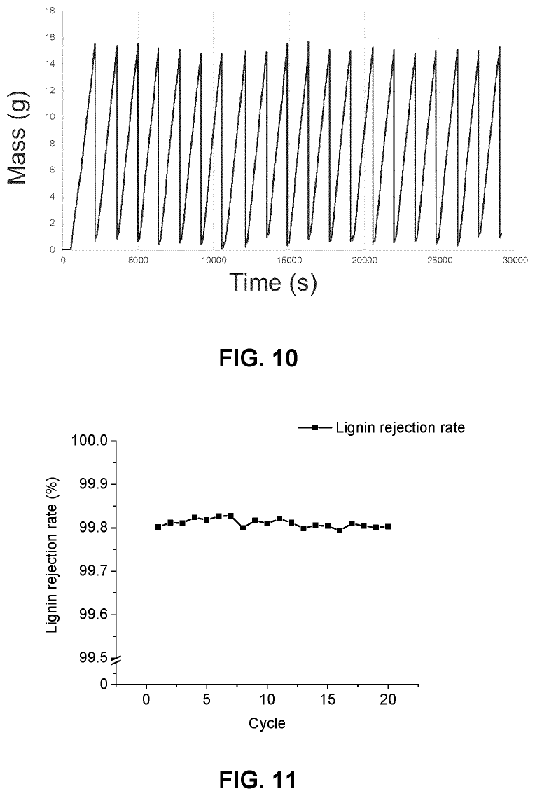

The performance of the GOPC was performed at 60° C. with the same parameters provided above (Table 1) and for 5 wt. % lignin solution. More specifically, a cycling test (20 cycles) was performed to evaluate the performance of the GOPC with continued use. The feedstock was replenished after each cycle. The permeated filtrate was collected for further investigation. The results are provided in FIG. 10. After 20 cycles no significant change in the filtration flow was found during the 20 cycle test. This results indicates the potential of antifouling properties of the present separation layers, particularly GOPC.

The filtrated solution was analyzed by laser transmission method with 0.01 wt. % lignin, 0.02 wt. % lignin and 0.05 wt. % lignin as the references. The results are shown in FIG. 11. The GOPC across the 20 cycles achieved a 99.9% rejection of lignin.

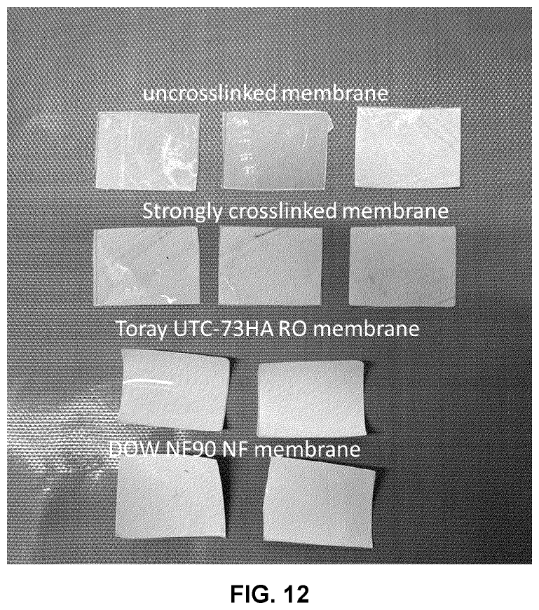

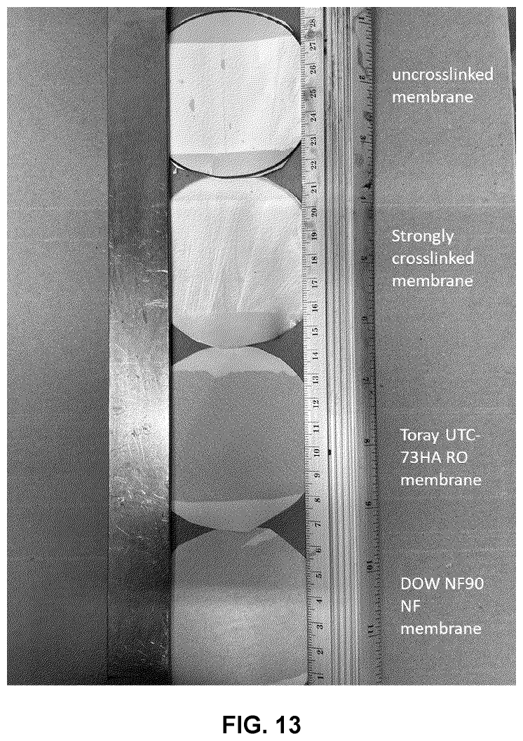

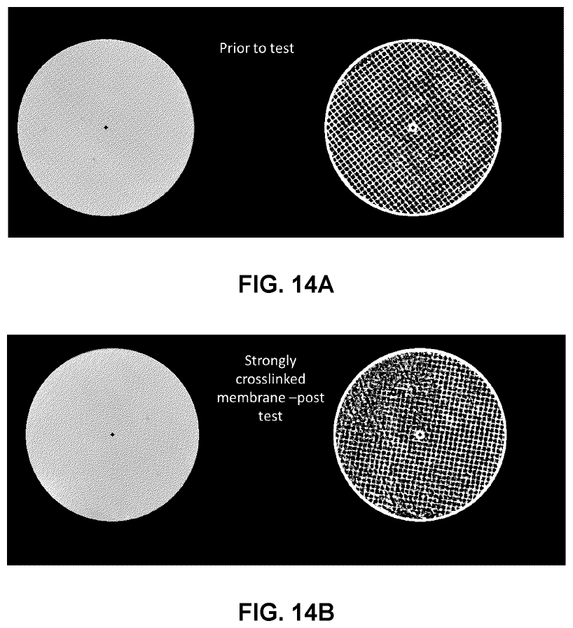

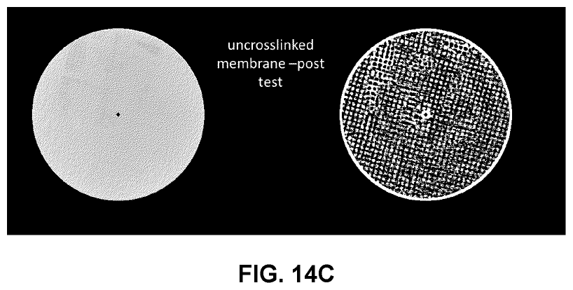

The effect of polyisocyanate crosslinkers on the adhesion under wet conditions was investigated. FIG. 12 shows wet adhesion test results showing the significant higher adhesion of strongly crosslinked membranes compared to uncrosslinked membranes (without crosslinkers). The membrane coupons were fully immersed in a 10 wt. % NaOH solution bottled in a PET jar. The jar was placed on a lab shaker and was agitated at 200 rpm for 5 hours. Delamination was found on the uncrosslinked membrane (white area) while no delamination was found on the strongly crosslinked membrane post test, which is comparable to the two commercial membranes at the bottom (Toray UTC-73HA RO membrane and DOW NF90 NF membrane). A dry adhesion test was also performed on the same membranes. FIG. 13 shows the results which show superior dry adhesion of strongly crosslinked membrane compared to all other tested membranes. 3M scotch tape was applied on each of the membrane coupon surface on the coated side and were peeled manually. FIGS. 14A-14C show the dry peeling test results with a protocol adapted from ASTM D3359. The coated layer was cut into 1 mm×1 mm squares using a laser marker and was subjected to the same tape test using 3M scotch tape. Images before and after the test were taken and were processed into grayscale (left) and contrast enhanced images (right) to better identify the areas of delamination. While the strongly crosslinked membrane retains most of the coated areas (shown as black squares) in FIG. 14B, almost all black squares on the uncrosslinked membrane in FIG. 14C disappeared and were replaced by white squares representing the delaminated area post test.

1-23. (canceled)

24. A composition comprising:
50 to 80 wt. % of a graphitic material comprising a plurality of layers;
1 to 49 wt. % of polymers; and
0.1 to 49-75 wt. % of crosslinkers selected from titanium chelates, zirconium chelates, dialdehydes, polyisocyanates or polyaziridines.

25. The composition of claim 24, wherein the crosslinkers are titanium chelates, zirconium chelates.

26. The composition of claim 25, wherein the crosslinkers are titanium (IV) oxide bis(2,4-pentanedionate).

27. The composition of claim 24, wherein the crosslinkers are dialdehydes.

28. The composition of claim 27, wherein the crosslinkers are glyoxal or glutaraldehyde.

29. The composition of claim 24, wherein the crosslinkers are polyaziridines or polyisocyanates.

30. The composition of claim 29, wherein the crosslinkers are trimethylolpropane tris(2-methyl-1-aziridinepropionate.

31. The composition of claim 24, wherein the polymers have hydroxyl, amine, carboxyl and/or epoxy groups.

32. The composition of claim 24, wherein the polymers are selected from polyvinyl alcohol, hydroxypropyl cellulose, polyacrylic acid, glycol, cellulose ethers, polyethyleneimine, polyurethane, polyepoxides and copolymers thereof.

33. The composition of claim 24, wherein the thickness of the graphitic material is between 5 nm and 50 μm.

34. The composition of claim 24, wherein the graphitic material is selected from the group consisting of graphite, graphene, graphite oxide, graphene oxide, reduced graphene oxide, and reduced graphite oxide.

35. The composition of claims 24, wherein the polymers and the crosslinkers are present in a weight ratio of polymer to crosslinker of from 1:100 to 10:1.

36. A filtration system comprising:
a first vessel adapted to receive a liquid phase;
a second vessel in fluid communication with the first vessel and adapted to receive a permeate of the liquid phase; and
a separation layer separating the first vessel and the second vessel, the separation layer having pores for filtering the liquid phase, and wherein the separation layer comprises a graphitic material, crosslinkers and a polymer coating.

37. The filtration system of claim 35, wherein the graphitic material is selected from the group consisting of graphite, graphene, graphite oxide, graphene oxide, reduced graphene oxide, reduced graphite oxide and functionalized counterparts thereof.

38. The filtration system of claim 35, further comprising a porous support substrate covered at least partially by the separation layer.

39. The filtration system of claim 35, wherein the porous support substrate comprises a material selected from the group consisting of polypropylene, polystyrene, polyethylene, polyethylene oxide, polyethersulfone, polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, ceramic, carbons, metals, silver, polycarbonate, nylon, aramid, polyether ether ketone, woven and non-woven fabrics.

40. The filtration system of claims 35, wherein the porous support substrate has an average pore size of from 0.01 μm to 50 μm.

41. The filtration system of claim 35, wherein the polymers are selected from the group consisting of glycol, cellulose ethers, polyvinyl alcohol, polyethyleneimine, polyacrylic acid, polyurethane, polyepoxides, polyisocyanates, polyvinyl acetates, polyacrylate, poly melamine, polyurea and copolymers thereof.

42. The filtration system of claim 35, wherein the crosslinkers are present in the separation layer in a concentration of between 1 and 20 wt. %

43. The filtration system of claim 42, wherein the crosslinkers are selected from the group consisting of aldehyde, isocyanate, aziridine, bisacrylamide, carbodiimide, silicon chelates, zirconium chelates, titanium chelates, polyamines, polycarboxylates, polyepoxides, polyaziridines, multivalent metal ions, polyanhydrides, borates, alkylated melamine, alkylated urea, polyiscoyanate and phosphates.
